(19) United States
(12) Patent Application Publication
(10) Pub. No.: US 2015/0327734 A1
(43) Pub. Date: Nov. 19, 2015

(54) STACK OF FOLDED ABSORBENT SHEET PRODUCTS, USE OF THE SAME IN A DISPENSER, METHOD AND MACHINE FOR MANUFACTURING THE SAME

(71) Applicant: SCA TISSUE FRANCE, Saint -Ouen (FR)

(72) Inventors: Yoann DENIS, Selestat (FR); Matti ELLONEN, Colmar (FR); Denis GENET, Marckolsheim (FR); Loïc SIEBER, Rixheim (FR)

(21) Appl. No.: 14/654,891

(22) PCT Filed: Dec. 24, 2012
(86) PCT No.: PCT/EP2012/076868

§ 371 Date: Jun. 23, 2015

(51) Int. Cl. A47K 10/16; A47K 10/42; B65G 57/00; B65D 83/08

(52) U.S. Cl. CPC A47K 10/16; B65D 83/0805; A47K 10/42; B65G 57/00

(57) ABSTRACT

A stack of folded absorbent sheet products includes a first absorbent sheet product folded according to a first type of folding, the first absorbent sheet product includes at least one fold wherein at least a first panel is coupled to at least a second panel through a folding line. Each first absorbent sheet product encloses as a whole a certain amount of a second absorbent sheet product between said at least first panel and second panel, the second absorbent sheet product being folded according to a second type of folding. The certain amount of the second absorbent sheet product is formed as a sub-stack that nests within the first absorbent sheet product so as to distribute the certain amount of absorbent sheet product with one grasping movement of the first absorbent sheet product.

### CROSS-REFERENCE TO PRIOR APPLICATION

This application is a §371 National Stage Application of PCT International Application No. PCT/EP2012/076868 filed Dec. 24, 2012, which is incorporated herein in its entirety.

### TECHNICAL FIELD

The disclosure relates to a stack of folded absorbent sheet products. The disclosure further relates to a use in a dispenser for distributing such a stack of folded absorbent sheet products. Still another aspect of the disclosure relates to a method for manufacturing such a stack of folded absorbent sheet products. Still another aspect of the disclosure relates to a machine for producing a stack of folded absorbent sheet products. The absorbent sheet products may be manufactured from a web of tissue paper (obtained by a Conventional Wet Press or Through Air Drying manufacturing method) or a nonwoven fabric including papermaking fibers (obtained by an air-laid manufacturing method). Such absorbent sheet products find a particular, though non exclusive, use as sanitary or domestic purposes. As an example, such absorbent sheet products may be used as napkins in quick service restaurant. Others uses as towels, bath tissues, etc. . . . may be possible.

### BACKGROUND

A tissue paper relates to an absorbent paper based on cellulose fiber which is also called a tissue paper base-sheet in this field of technology. A typical absorbent paper has a low basis weight, in the range from 10 to 50 g/m².

A nonwoven fabric comprising cellulosic fibers relates to an absorbent paper which is also called nonwoven or web made of fibers like air-laid web in this field of technology. A typical absorbent paper has a basis weight, in the range from 30 to 250 g/m², or, in particular embodiments, 40 to 80 g/m².

There exist various types of dispensers for distributing absorbent sheet products to users. Often, such dispensers are provided in restaurants (e.g. fast food restaurants also known as quick service restaurants) or other public places. The users remove an amount of absorbent sheet products from the dispenser. The capacity of such dispenser may be adapted to the intended use. For example, in the context of a fast-food restaurant, a large number of napkins may be distributed in a short period of time to an important number of users. However, in such a context, this often results in difficulty to uniformly dispense a controlled number of napkins that is sufficient for the needs of the users, and/or a reasonable number of napkins that is not larger than necessary for the needs of the users. It is particularly difficult for a user to control the number of napkins distributed in one grasping movement. In the context of, for example, fast food restaurants, as the distribution must be done quickly, it is unthinkable to count the number of distributed napkins in one grasping movement. There is a compromise between the overconsumption of towels, and the gain or loss of time due to the distribution.

Thus, there is a need to improve quality of distribution, uniformity of distribution and also to avoid wasting absorbent sheet products that are unnecessary to the users. Further, this should be obtained in economical or cost effective manner.

### SUMMARY

It is desired to propose a stack of folded absorbent sheet products that overcomes the drawbacks of the prior art absorbent sheet products. In particular, it is desirable to improve uniformity of distribution of absorbent sheet products to a user.

According to embodiments of the invention, it is proposed to form a pocket in an absorbent sheet product that includes multiple absorbent sheet products inside.

According to one aspect, there is provided a stack of folded absorbent sheet products including a first absorbent sheet product folded according to a first type of folding, the first absorbent sheet product including at least one fold wherein at least a first panel is coupled to at least a second panel through a folding line, wherein each first absorbent sheet product encloses as a whole a certain amount of a second absorbent sheet product between said at least first panel and second panel, the second absorbent sheet product being folded according to a second type of folding, and wherein the certain amount of the second absorbent sheet product is formed as a sub-stack that nests within the first absorbent sheet product so as to distribute the certain amount of absorbent sheet product with one grasping movement of the first absorbent sheet product.

The first type of folding may be either identical or different to the second type of folding.

The first type of folding may be chosen among the group comprising V-fold wherein two panels are created by one fold, C-fold wherein three panels are created by two folds made in same directions, Z-fold wherein three panels are created by two folds made in opposite directions, and M-fold wherein four panels are created by three folds.

The second type of folding may be chosen among the group comprising V-fold wherein two panels are created by one fold, C-fold wherein three panels are created by two folds made in same directions, Z-fold wherein three panels are created by two folds made in opposite directions, and M-fold wherein four panels are created by three folds.

The respective sizes of the first absorbent sheet product relative to the second absorbent sheet product may be identical.

The respective sizes of the first absorbent sheet product relative to the second absorbent sheet product may be different.

The first and second absorbent sheet products may be chosen among the group of absorbent sheet products comprising napkins and towels.

According to another aspect, there is provided a use of a stack of folded absorbent sheet products in a dispenser wherein the dispenser includes a container filled with a distributing bundle made of stacks of folded absorbent sheet products stacked on each other or one beside the other, the stack of folded absorbent sheet products being oriented in the dispenser so that when a user grasps a first absorbent sheet product, a certain amount of a second absorbent sheet product encompassed in the first absorbent sheet product is seized at the same time.

A front face of the dispenser may include an opening allowing a first stack of folded absorbent sheet products to gape the container and through which the stack of folded absorbent sheet products is seized.

The opening may be extended by an additional opening zone positioned on the top part along the length of the opening, or only along a portion of the length of the opening, or in the corner of the opening.

According to a further aspect, there is provided a method for manufacturing a stack of folded absorbent sheet products, wherein the method comprising:
folding sheets issued from two tissue webs and stacking said sheets such that a folded first sheet encloses as a whole a certain amount of folded second sheet;
adjusting the first speed of folding the first sheet relative to the second speed of folding the second sheet such that the first speed is greater than the second speed in a ratio depending on the amount of folded second sheet to be encompassed into each folded first sheet.

The first sheet may be folded according to a method of folding chosen among the group comprising V-fold wherein two panels are created by one fold, C-fold wherein three panels are created by two folds made in same directions, Z-fold wherein three panels are created by two folds made in opposite directions, and M-fold wherein four panels are created by three folds.

The second sheet may be folded according to a method of folding chosen among the group comprising V-fold wherein two panels are created by one fold, C-fold wherein three panels are created by two folds made in same directions, Z-fold wherein three panels are created by two folds made in opposite directions, and M-fold wherein four panels are created by three folds.

According to still a further aspect, there is provided a machine for manufacturing a stack of folded absorbent sheet products, wherein:
the machine includes a first and second folding unit each including at least one folding roller arranged to be supplied by a first and second tissue web, respectively;
each roller of the first folding unit being arranged to be rotated at substantially a first speed, each roller of the second folding unit being arranged to be rotated at a second speed;
the first and second folding roller being positioned in a face to face configuration so as to enable folding of a first sheet product with respect to a second sheet product such that a folded first sheet encloses as a whole a certain amount of folded second sheet; and
an adjustment module arranged to adjust the first speed of folding the first sheet relative to the second speed of folding the second sheet such that the first speed is greater than the second speed in a ratio depending on the quantity amount of folded second sheet to be encompassed into each folded first sheet.

According to still a further aspect, there is provided a use of a stack of folded absorbent sheet products as napkins in a dispenser.

Because the panels of the first and second absorbent sheet products nest together, the stack forms a self-contained group of napkins that is easy to handle. Thus, it is possible to distribute a given number of napkins with every grasping movement, for example, three towels. This is of particular interest in the context of fast-food restaurant applications. This is also well adapted to uniformly dispense a controlled amount of paper products from a large dispenser without dispensing more paper products than necessary to a user. This enables limiting the quantity of paper products that is removed by a user, and thus limiting waste of paper products.

Further, reducing the waste of consumption results in economical and environmental benefits, as similar or even better satisfaction of the users is obtained while using fewer paper products.

Other advantages will become apparent from the hereinafter description of embodiments of the invention.

### BRIEF DESCRIPTION OF THE DRAWINGS

Embodiments of the invention are illustrated by way of examples and not limited to the accompanying drawings, in which like references indicate similar elements:

FIGS. 1 to 13 schematically illustrate side cross-section views of exemplary embodiments of stacks of folded absorbent sheet product;

FIGS. 14 to 18 schematically illustrate various exemplary embodiments of dispensers for distributing stacks of folded absorbent sheet products; and

FIG. 19 schematically and partially illustrates an example of a machine and method for manufacturing stacks of folded absorbent sheet products.

### DETAILED DESCRIPTION OF PARTICULAR EMBODIMENTS

FIGS. 1 to 13 schematically illustrate side cross-section views of exemplary embodiments of stacks of folded absorbent sheet products.

In all of these exemplary embodiments, a first sheet product folded according to a first type of folding encloses at least one second sheet product folded according to a second type of folding. Advantageously, the first sheet product folded according to the first type of folding encloses a certain amount of the second sheet product folded according to the second type of folding. The certain amount may be two, three, four or more. The certain amount of the second sheet product folded according to the second type of folding is formed as a sub-stack.

FIG. 1 is a side cross-section view in a stack of folded absorbent sheet products 1 schematically illustrating a first embodiment. A first sheet product 10 is folded according to a V-Fold type of folding. A V-Fold is a type of folding wherein one fold creates two panels. Thus, the first sheet product 10 includes a first panel 11 coupled to a second panel 12 through a folding line 13. The first sheet product 10 encloses a plurality, for example two, second sheet products 20. Each second sheet products 20 folded according to a V-Fold type of folding includes a first panel 21 coupled to a second panel 22 through a folding line 23. The second sheet product 20 is positioned with respect to the first sheet product 10 such that the respective folding lines 13, 23 are positioned opposite or spaced apart from each other.

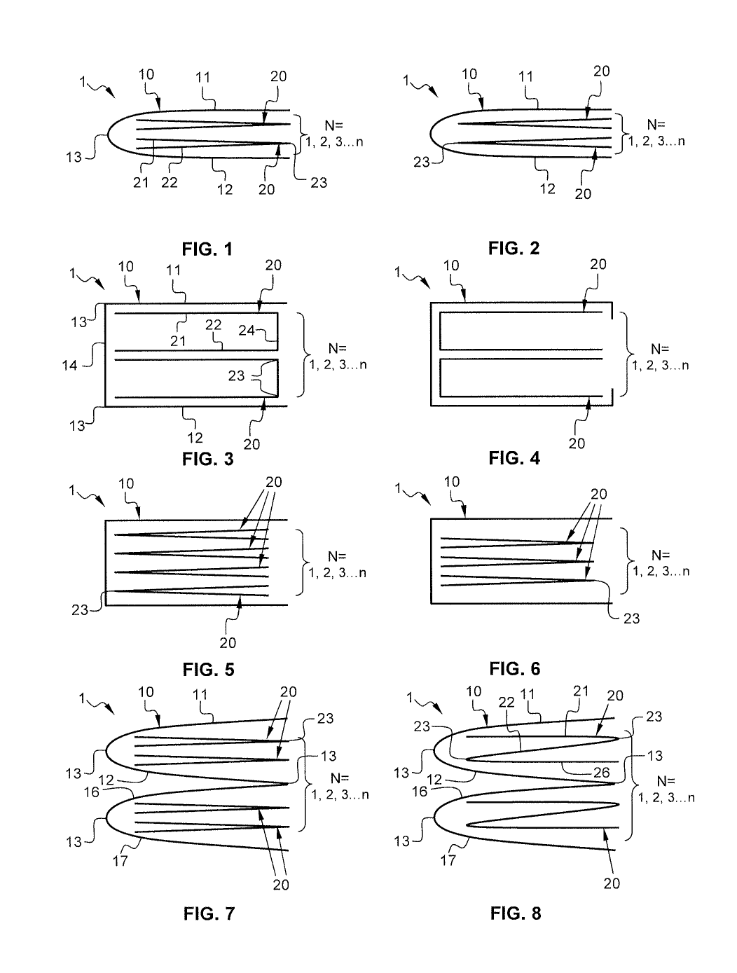

FIG. 2 is a side cross-section view in a stack of folded absorbent sheet products 1 schematically illustrating a second embodiment. The second embodiment differs from the first embodiment in that the second sheet product 20 is positioned with respect to the first sheet product 10 such that the respective folding lines 13, 23 are positioned in vis-à-vis or closed to each other.

FIG. 3 is a side cross-section view in a stack of folded absorbent sheet products 1 schematically illustrating a third embodiment. A first sheet product 10 folded according to a C-Fold type of folding. A C-Fold is a type of folding wherein at least two fold creates at least three panels, each section being approximately one third the length of the sheet. Thus, the first sheet product 10 includes a first panel 11 coupled to a back panel 14 through a folding line 13, the back panel 14 being coupled to a second panel 12 through another folding line 13. The first sheet product 10 encloses a plurality, for example two, second sheet products 20. Each second sheet products 20 folded according to a C-Fold type of folding includes a first outer panel 21 coupled to a back panel 24 through a folding line 23, the back panel 24 being coupled to a second outer panel 22 through another folding line 23. The outer panels 21, 22 are folded toward each other. The second sheet product 20 is positioned with respect to the first sheet product 10 such that the respective folding lines 13, 23 are positioned opposite or spaced apart from each other.

FIG. 4 is a side cross-section view in a stack of folded absorbent sheet products 1 schematically illustrating a fourth embodiment. The fourth embodiment differs from the third embodiment in that the second sheet product 20 is positioned with respect to the first sheet product 10 such that the respective folding lines 13, 23 are positioned in vis-à-vis or closed to each other.

FIG. 5 is a side cross-section view in a stack of folded absorbent sheet products 1 schematically illustrating a fifth embodiment. The fifth embodiment differs from the third embodiment in that the second sheet products 20 are folded according to a V-Fold type of folding. In the depicted example, the first sheet product 10 encloses, as an example, four second sheet products 20.

FIG. 6 is a side cross-section view in a stack of folded absorbent sheet products 1 of the invention schematically illustrating a sixth embodiment. The sixth embodiment differs from the fourth embodiment in that the second sheet products 20 are folded according to a V-Fold type of folding. In the depicted example, the first sheet product 10 encloses, as an example, three second sheet products 20.

FIG. 7 is a side cross-section view in a stack of folded absorbent sheet products 1 schematically illustrating a seventh embodiment. A first sheet product 10 folded according to an M-Fold type of folding. An M-Fold is a type of folding wherein three folds create four panels, each section being approximately one quarter of the length of the sheet. Thus, the first sheet product 10 includes a first panel 11 coupled to a second panel 12 through a folding line 13, the second panel 12 being coupled to a third panel 16 through another folding line 13, the third panel 16 being coupled to a fourth panel 17 through another folding line 13. The first sheet product 10 encloses a plurality, for example four, second sheet products 20. In particular, in this example, the first sheet product 10 encloses two second sheet products 20 between the first 11 and second 12 panels and two other between the third 16 and fourth 17 panels. Each second sheet products 20 folded according to a V-Fold type of folding includes a first panel coupled to a second panel through a folding line 23. The second sheet product 20 is positioned with respect to the first sheet product 10 such that the folding lines 23 are positioned opposite or spaced apart from the folding lines 13 between the first 11 and second 12 panels, and the third 16 and fourth 17 panels, respectively.

FIG. 8 is a side cross-section view in a stack of folded absorbent sheet products 1 schematically illustrating an eighth embodiment. The eighth embodiment differs from the seventh embodiment in that the second sheet products 20 are folded according to a Z-Fold type of folding. A Z-Fold is a type of folding wherein two folds create three panels, each section being approximately one third of the length of the sheet. Thus, the second sheet product 20 includes a first panel 21 (outer panel) coupled to a second panel 22 (central panel) through a folding line 23, and the second panel 22 (central panel) being coupled to a third panel 26 (outer panel) through another folding line 13. The folds of the outer panels are made in opposite directions (each outer panel is folded toward another side of the central panel) so that the shape forms the letter “Z”. In the depicted example, the first sheet product 10 encloses, as an example, two second sheet products 20. In particular, in this example, the first sheet product 10 encloses one second sheet product 20 between the first 11 and second 12 panels and another one between the third 16 and fourth 17 panels.

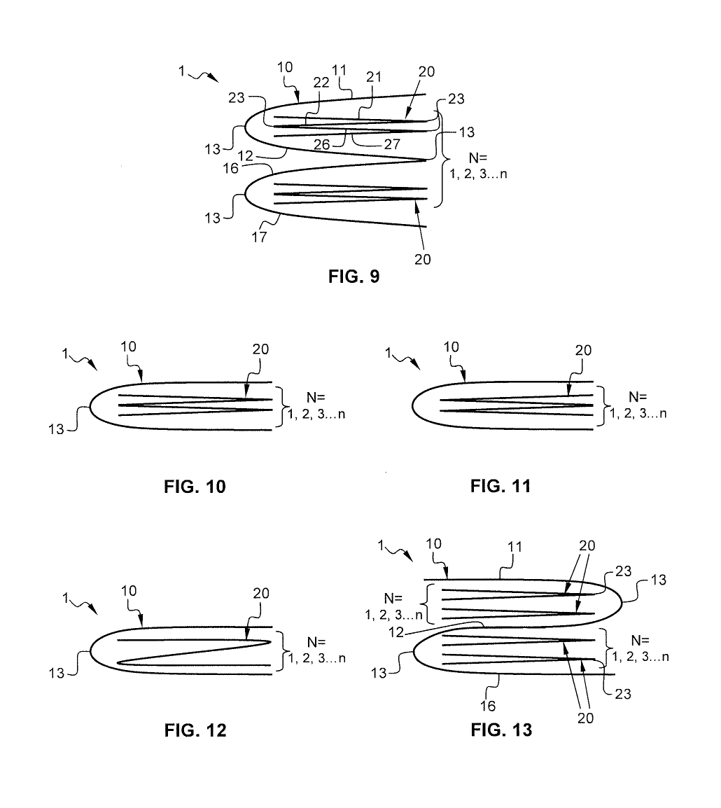

FIG. 9 is a side cross-section view in a stack of folded absorbent sheet products 1 schematically illustrating a ninth embodiment. The ninth embodiment differs from the seventh embodiment in that the second sheet products 20 are folded according to an M-Fold type of folding. In the depicted example, the first sheet product 10 encloses, as an example, two second sheet products 20. In particular, in this example, the first sheet product 10 encloses one second sheet product 20 between the first 11 and second 12 panels and another one between the third 16 and fourth 17 panels. The second sheet product 20 is positioned with respect to the first sheet product 10 such that the second sheet product 20 is orientated in the same direction or inversed relative to the first sheet product 10.

FIGS. 10, 11 and 12 are a side cross-section view in a stack of folded absorbent sheet products 1 schematically illustrating a tenth, eleventh and twelfth embodiment. These embodiments differ from the first embodiment in that the second sheet products 20 are folded according to an M-Fold type of folding (FIGS. 10 and 11) and Z-fold type of folding (FIG. 12). In the embodiments depicted in FIGS. 10 and 11, the orientation of the second sheet product 20 within the first sheet product 10 is merely inversed.

FIG. 13 is a side cross-section view in a stack of folded absorbent sheet products 1 schematically illustrating a thirteenth embodiment. A first sheet product 10 folded according to a Z-Fold type of folding. The first sheet product 10 includes a first panel 11 coupled to a second panel 12 through a folding line 13, and the second panel 12 being coupled to a third panel 16 through another folding line 13. The first sheet product 10 encloses a plurality, for example four, second sheet products 20. In particular, in this example, the first sheet product 10 encloses two second sheet products 20 between the first 11 and second 12 panels and two other between the second 12 and the third 16 panels. Each second sheet products 20 folded according to a V-Fold type of folding includes a first panel coupled to a second panel through a folding line 23. The second sheet product 20 is positioned with respect to the first sheet product 10 such that the respective folding lines 13, 23 are positioned opposite or spaced apart from each other.

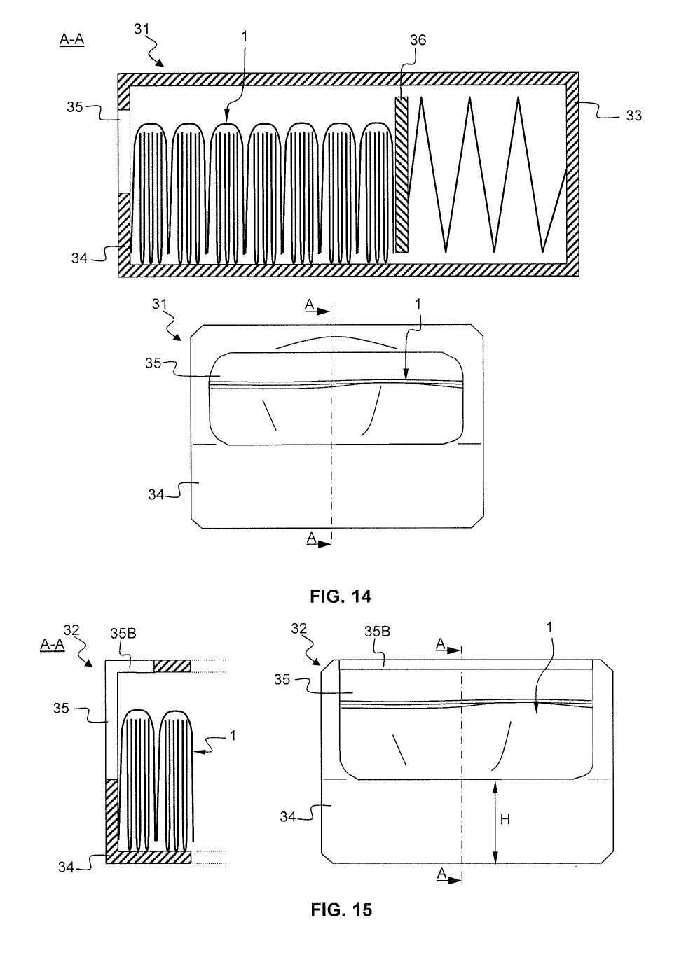

The hereinbefore presented embodiments may be used for folding and stacking napkins that can be used in e.g. fast-food restaurant. A napkin encloses a certain amount of napkins forming a group of napkins of a certain amount. Several groups of napkins are stacked on each other or one beside the other in order to fill-in a container of a dispenser. Advantageously, the groups of napkins are oriented in the dispenser so that when a user grasps a napkin, all the napkins of a group are seized at the same time. However, the way of folding and stacking napkins is versatile in the sense that it is also possible to inversely orient the groups of napkins in the dispenser so that a user may grasp a single napkin at a time. Thus, the operator refilling the dispenser has the possibility to choose between two ways of dispensing the napkins, several napkins in one grasping movement vs one napkin per grasping movement. FIGS. 14 to 18 schematically illustrate various exemplary embodiments of dispensers for distributing such stacks of folded absorbent sheet products, e.g. napkins.

FIG. 14 is a front view (bottom) and a lateral cross-section view (top) according to the line A-A of the front view schematically illustrating a horizontal dispenser 31. The dispenser 31 includes a container 33 of substantially parallelepiped shape orientated horizontally, a front face 34 provided with an opening 35, and a mechanism 36 for pushing napkins towards the front face 34. The container is filled in with a plurality of stack of folded absorbent sheet products, for example a stack of folded napkins positioned vertically. A user grasps a stack of folded napkins 1 through the opening 35.

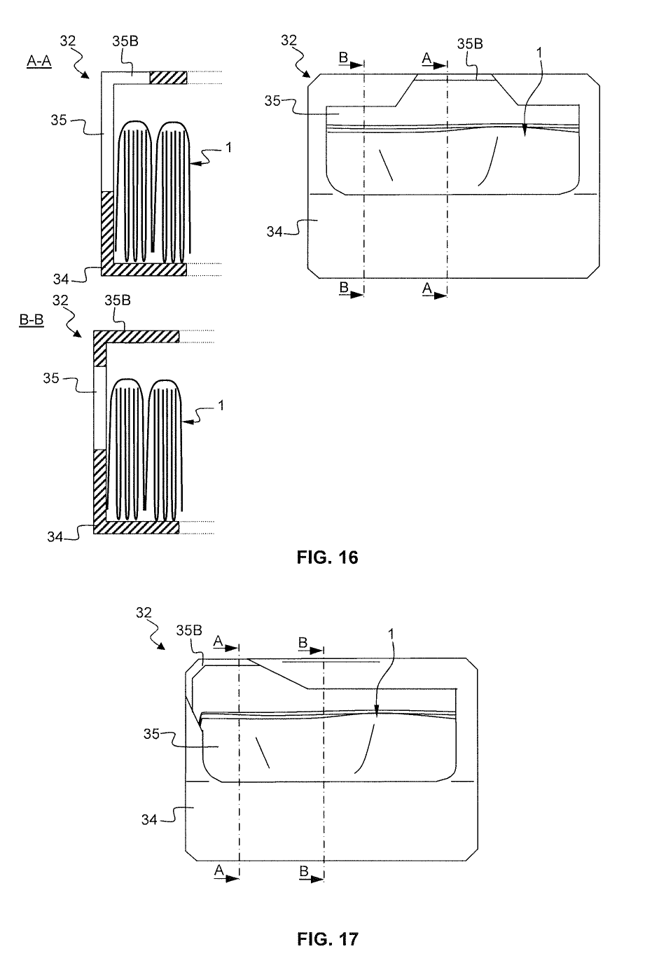

FIGS. 15 to 17 show a front view and at least one side cross-section view along lines A-A and B-B of several alternative embodiments. In particular, FIG. 15 is a front view (right) and a lateral cross-section view (left) according to the line A-A of the front view schematically illustrating another embodiment of an horizontal napkins dispenser 32. FIGS. 16 and 17 are a front view (right and center respectively) and two lateral cross-section views according to the lines A-A and B-B of the front view (left top and left bottom respectively, in FIG. 16) schematically illustrating alternative embodiments of the horizontal napkins dispenser 32.

The front face 34 of the dispenser has been modified by adding an additional opening zone 35B to the opening 35 such as to create a gripping zone. The additional opening zone 35B allows the first stack of folded napkins to gape the container 32 and eases the user's fingers to grasp the first stack of folded napkins 1 out of the container.

In the first alternative embodiment shown in FIG. 15, the additional opening zone 35B is positioned along the top of the existing opening 35 releasing an upper part of the container 33 close to the front face 34. The height H of the positioning of the opening 35 in the front face 34 relative to a base of the container on a supporting surface can be adjusted to modulate the gape of the first stack of folded napkins 1.

In the second alternative embodiment shown in FIG. 16, the additional opening zone 35B is positioned on the top part only along a portion of the length of the existing opening 35. It releases an upper part of the container 33 near the front face 34 at right of the additional opening zone 35B. The additional opening zone 35B can be positioned substantially in the middle of this length and has dimensions such that at least one finger can slip into the additional opening zone 35B in order to grasp a stack of folded napkins.

In the third alternative embodiment shown in FIG. 17, the additional opening zone 35B is positioned in the top corner to the left or right (adapting to the left or right handed) of the existing opening 35. It releases an upper part of the container 33 close to the front face 34 at a corner. The additional opening zone 35B has dimensions such that at least one finger can slip into the additional opening zone 35B in order to grasp a stack of folded napkins.

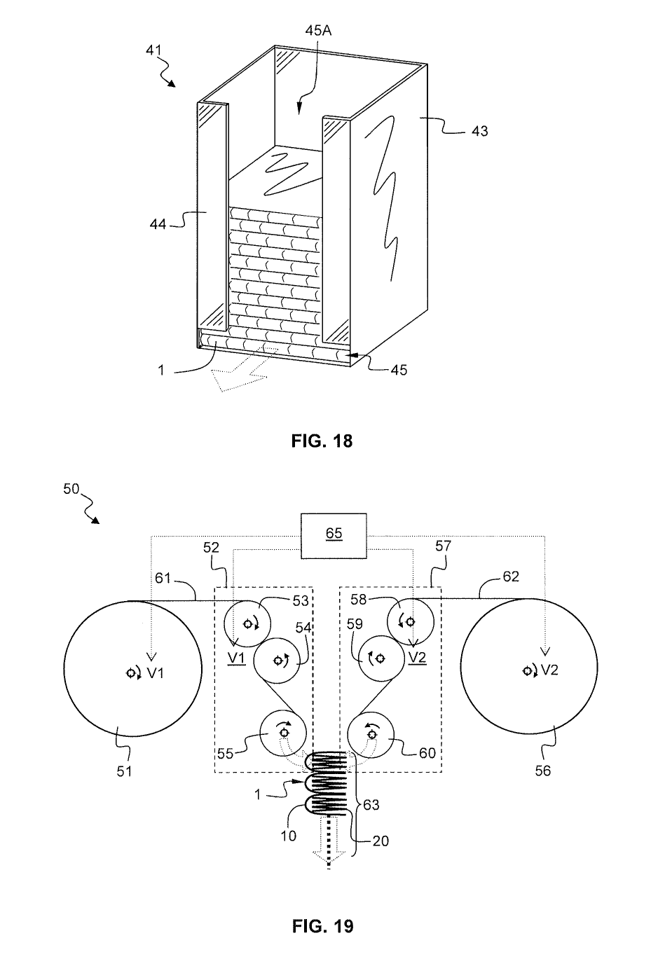

FIG. 18 is a perspective view schematically illustrating a vertical dispenser 41.

The dispenser 41 includes a container 43 of substantially parallelepiped shape orientated vertically, a front face 44 provided with an opening 45. The container is filled in with a plurality of stack of folded absorbent sheet products 1, for example a stack of folded napkins positioned vertically. The plurality of stack of folded absorbent sheet products falls naturally towards the bottom of the container because of its own mass so that there is always at least one stack of folded absorbent sheet products 1 facing the opening 45. A user grasps a stack of folded napkins 1 through the opening 45.

The front face 44 includes a vertical slit 45A, for example positioned in the middle of the front face that may extend from the opening 45 all along the front face 44. The vertical slit 45A has dimensions such that at least one finger can slip into the vertical slit 45A in order to grasp a stack of folded napkins 1.

FIG. 19 schematically and partially illustrates an example of a method and machine for manufacturing stacks of folded absorbent sheet products.

The manufacturing method includes the steps of folding sheets issued from two tissue webs and stacking said sheets such that a folded first sheet encloses at least one, advantageously a plurality of folded second sheet. This is obtained by adjusting the first speed V1 of folding the first sheet relatively to the second speed V2 of folding the second sheet. For example, the first speed V1 is greater than the second speed V2 in a ratio depending on the quantity of second folded sheet to be grouped into each folded first sheet. Further to the speed, the adjustment may further require defining an offset of folding of the first sheet relative to the second sheets.

The manufacturing machine 50 enables forming identical folds in sheets of a first type and identical folds in sheets of a second type issued from two different tissue webs, and assembling by folding a certain amount of sheet of the second type of into each sheet of the first type in a continuously moving stack 63.

First and second tissue webs 61, 62 are led simultaneously to the machine 50 from suitable supply rolls 51, 56, respectively.

The first and second tissue webs 61, 62 are unwound (in an unfolded condition) at an appropriate speed V1, V2 towards a first and second folding unit 52, 57, respectively. Each folding unit 52, 57 includes multiple rollers, e.g. a cutting roller 53, 58 respectively, a transporting roller 54, 59, respectively, and at least one folding roller 55, 60, respectively. Each roller of the first folding unit 52 is rotating at substantially the first speed V1. Each roller of the second folding unit 57 is rotating at substantially the second speed V2. Each tissue web 61, 62 is cut to an appropriate length by the cutting roller 53, 58 and then transported to the folding roller 55, 60, respectively. The first and second folding units 52, 57, in particular the first and second folding roller 55, 60 are positioned in a face to face configuration so as to enable folding of the first sheet product 10 with respect to the second sheet product 20. The first and second folding roller 55, 60 are located in spaced relationship with each other along the path of the stack 63 beneath them. Typically, the cutting roller 53, 58 may include a knife and the transporting roller 54, 59 may include a knife hammer (not shown). Typically, the folding roller 55, 60 may be of the air suction folding type that includes suction outlets and blowing outlets in order to maintain and fold panels in the cut sections of tissue webs 61, 62. Alternatively, the folding roller 55, 60 may be of the mechanical folding type that includes folding fingers in order to maintain and fold panels in the cut sections of tissue webs 61, 62. As a further alternative, the folding roller 55, 60 may be a combination of the air suction folding type and mechanical folding type. An adjustment module 65 may be arranged to adjust the first speed V1 relative to the second speed V2.

FIG. 19 depicts an example wherein multiple stacks of folded absorbent sheet products 1 according to the first embodiment are produced. In the frame of this embodiment, the first folding roller 55 forms a longitudinal median fold 13 in the first cut tissue web 61, such that the cross-section of the web forms a “V” having two panels as explained hereinbefore with respect to FIG. 1. A first sheet product 10 is produced at the first speed V1. The second folding roller 60 forms a longitudinal median fold 23 in the first cut tissue web 61, such that the cross-section of the web also forms a “V” having two panels. A second sheet product 20 is produced at the second speed V2. The second sheet product 20 is positioned with respect to the first sheet product 10 such that the respective folding lines 13, 23 are positioned opposite from each other. The speed V2 being superior to the speed V1 in an appropriate ratio, multiple, for example three sheet products of the second type 20 are produced while only one sheet product of the first type 10 is produced. This group of three sheet products of the second type 20 is formed onto the first panel of the first sheet product 10. When the folding step of the first sheet product 10 ends, already a group of the second sheet products 20 has been produced (sub-stack) so that the second panel of the first sheet product 10 is applied onto this group so as to enclose it. The group of the second sheet products 20 nests within the first sheet product 10. The above steps repeat continuously so as to form a stack 63 of folded absorbent sheet products 1. A given number of such folded absorbent sheet products 1 may then be packaged in wrappers or boxes (not shown).

FIG. 19 depicts that the rollers associated with the first folding unit as identical and symmetrical with respect to the rollers associated with the second folding unit. Alternatively, the rollers may be different, for example the dimensions of the rollers of one folding unit may be different from the other in order to adapt different size of tissue webs or cut tissue webs and folds absorbent sheet products of different sizes (in the case where the dimensions of the first absorbent sheet product is different to the ones of the second absorbent sheet products).

The drawings and their descriptions hereinbefore illustrate rather than limit the invention.

Though the invention has been described with respect to various embodiments of folded absorbent sheet products wherein one external folded tissue product (first sheet product 10) includes one, two or three internal folded tissue products (second sheet products 20), these are not limitative examples. The skilled person will readily recognize that the folded absorbent sheet products may include more internal folded tissue products, e.g. four, five, six, etc. . . . provided that the folded absorbent sheet products may still be grasped by one hand. The particular application of the product as napkins in the frame of fast-food restaurant application is only an example as numerous other sanitary or domestic applications are also possible.

Also the various types of folding in the depicted embodiments are non limitative examples. The skilled person will readily recognize that these types of folding may be changed if desired or deemed necessary with respect to, for example, the uniformity of distribution, the practicality or even the desired aesthetic effect to be achieved.

Any reference sign in a claim should not be construed as limiting the claim. The word “comprising” does not exclude the presence of other elements than those listed in a claim. The word “a” or “an” or “at least one” preceding an element does not exclude the presence of a plurality of such element.

1. A stack of folded absorbent sheet products comprising a first absorbent sheet product folded according to a first type of folding, the first absorbent sheet product comprises at least one fold wherein at least a first panel is coupled to at least a second panel through a folding line,
wherein each first absorbent sheet product encloses as a whole a certain amount of a second absorbent sheet product between said at least first panel and second panel, the second absorbent sheet product being folded according to a second type of folding, and
wherein the certain amount of the second absorbent sheet product being formed as a sub-stack that nests within the first absorbent sheet product so as to distribute the certain amount of absorbent sheet product with one grasping movement of the first absorbent sheet product.

2. The stack of folded absorbent sheet products of claim 1, wherein the first type of folding is identical to the second type of folding.

3. The stack of folded absorbent sheet products of claim 1, wherein the first type of folding is chosen from among the group consisting of V-fold, wherein two panels are created by one fold; C-fold, wherein three panels are created by two folds made in same directions; Z-fold, wherein three panels are created by two folds made in opposite directions; and M-fold, wherein four panels are created by three folds.

4. The stack of folded absorbent sheet products according to claim 1, wherein the second type of folding is chosen from among the group consisting of V-fold, wherein two panels are created by one fold; C-fold, wherein three panels are created by two folds made in same directions; Z-fold, wherein three panels are created by two folds made in opposite directions; and M-fold, wherein four panels are created by three folds.

5. The stack of folded absorbent sheet products according to claim 1, wherein the respective sizes of the first absorbent sheet product relative to the second absorbent sheet product are identical.

6. The stack of folded absorbent sheet products according to claim 1, wherein the respective sizes of the first absorbent sheet product relative to the second absorbent sheet product are different.

7. The stack of folded absorbent sheet products according to claim 1, wherein the first and second absorbent sheet products are chosen from among the group of absorbent sheet products consisting of napkins and towels.

8. A dispenser comprising, a container filled with a distributing bundle made of stacks of folded absorbent sheet products according to claim 1 stacked on each other or one beside the other, wherein the stacks of folded absorbent sheet products are oriented in the dispenser so that when a user grasps a first absorbent sheet product, a certain amount of a second absorbent sheet product (20) encompassed in the first absorbent sheet product is seized at the same time.

9. The dispenser of claim 8, wherein a front face of the dispenser comprises an opening allowing a first stack of folded absorbent sheet products to gape of the container and through which the stack of folded absorbent sheet products is seized.

10. The dispenser of claim 9, wherein the opening is extended by an additional opening zone positioned on the top part along the length of the opening, or only along a portion of the length of the opening, or in the corner of the opening.

11. A method for manufacturing a stack of folded absorbent sheet products according to claim 1, wherein the manufacturing method comprises:
folding sheets issued from two tissue webs and stacking said sheets such that a folded first sheet encloses as a whole a certain amount of folded second sheet;
adjusting the first speed of folding the first sheet relatively to the second speed of folding the second sheet such that the first speed is greater than the second speed in a ratio depending on the amount of folded second sheet to be encompassed into each folded first sheet.

12. The manufacturing method of claim 11, wherein the folding of the first sheet is identical to the folding of the second sheet.

13. The manufacturing method of claim 11, wherein the first sheet is folded according to a method of folding chosen from among the group consisting of V-fold, wherein two panels are created by one fold; C-fold, wherein three panels are created by two folds made in same directions; Z-fold, wherein three panels are created by two folds made in opposite directions; and M-fold, wherein four panels are created by three folds.

14. The manufacturing method according to claim 11, wherein the second sheet is folded according to a method of folding chosen from among the group consisting of V-fold, wherein two panels are created by one fold; C-fold, wherein three panels are created by two folds made in same directions; Z-fold, wherein three panels are created by two folds made in opposite directions; and M-fold, wherein four panels are created by three folds.

15. A machine for manufacturing a stack of folded absorbent sheet products according to claim 1, comprising:
a first and second folding unit each comprising at least one folding roller arranged to be supplied by a first and second tissue web, respectively, wherein each roller of the first folding unit is arranged to be rotated at substantially a first speed, each roller of the second folding unit being arranged to be rotated at a second speed, and wherein the first and second folding roller are positioned in a face to face configuration so as to enable folding of a first sheet product with respect to a second sheet product such that a folded first sheet encloses as a whole a certain amount of folded second sheet;
an adjustment module arranged to adjust the first speed of folding the first sheet relative to the second speed of folding the second sheet such that the first speed is greater than the second speed in a ratio depending on the amount of folded second sheet to be encompassed into each folded first sheet.

16. A dispenser comprising the stack of folded absorbent sheet products according to claim 1 as napkins.

17. The stack of folded absorbent sheet products of claim 1, wherein the first type of folding is different from the second type of folding.

18. The manufacturing method of claim 11, wherein the folding of the first sheet is different from the folding of the second sheet.
